(19) United States
(12) Patent Application Publication
(10) Pub. No.: US 2025/0004339 A1
(43) Pub. Date: Jan. 2, 2025

(54) HOLOGRAPHIC DISPLAYS AND METHODS

(71) Applicant: VividQ Limited, London (GB)

(72) Inventors: Alfred James NEWMAN, London (GB); Christian FIELDHOUSE, London (GB)

(21) Appl. No.: 18/830,388

(22) Filed: Sep. 10, 2024

Related U.S. Application Data
(63) Continuation of application No. PCT/GB2023/050651, filed on Mar. 17, 2023.

(30) Foreign Application Priority Data
Mar. 25, 2022 (GB) 2204235.2

(51) Int. Cl. G02F 1/137; G02F 1/01; G02F 1/1335; G03H 1/22

(52) U.S. Cl. CPC G02F 1/137; G02F 1/0136; G02F 1/133528; G03H 1/2294; G03H 2223/22; G03H 2225/22

(57) ABSTRACT

A holographic display is provided. The display comprises (i) an illumination source configured to emit at least partially coherent light, (ii) a liquid crystal layer comprising an array of elements arranged to be illuminated by the light. The layer is configured such that: (a) when a first electric field is applied across an element of the liquid crystal layer, the light from the element has a first polarisation state, (b) when a second electric field is applied across the element, the light has a second polarisation state, and (c) when a third electric field is applied across the element, the light has a third polarisation state. The display further comprises (iii) a controller configured to control electric fields applied across the elements, and (iv) an output polarising element, configured to: (a) remove a portion of light having the first polarisation state and also transmit a portion of the light having the first polarisation state, (b) remove substantially all of the light having the second polarisation state, and (c) remove a portion of the light having the third polarisation state and also transmit a portion of the light having the third polarisation state. In this display, one of: (1) the second electric field is greater than the first electric field, and the third electric field is greater than the second electric field; and (2) the second electric field is lower than the first electric field, and the third electric field is lower than the second electric field.

### CROSS-REFERENCE TO RELATED APPLICATIONS

This application is a continuation under 35 U.S.C. § 120 of International Application No. PCT/GB2023/050651, filed Mar. 17, 2023, which claims priority to GB Application No. 2204235.2, filed Mar. 25, 2022, under 35 U.S.C. § 119 (a). Each of the above-referenced patent applications is incorporated herein by this reference in its entirety.

### TECHNICAL FIELD

The present invention relates to holographic displays and methods of operating holographic displays.

### BACKGROUND

Computer Generated Holography, CGH, is known. A holographic light field is determined for holographic display using coherent or at least partially coherent light and is defined in terms of an amplitude and phase of each element (such as a pixel) of a display. This combination results in a light field that is perceived, by a viewer, to have depth information.

An ideal spatial light modulator (SLM) in a holographic display is capable of full-complex modulation where the amplitude and phase values for each pixel of the hologram can be varied to closely resemble the determined amplitude and phase of the light field. In other words, an ideal SLM is capable of displaying all possible combinations of phase and amplitude.

In practice, SLMs used for CGH cannot achieve perfect full-complex modulation. Typically, the SLMs may only have a very limited number of values they can display. For example, the SLMs may only be capable of modulating one of amplitude or phase. The resolution may also be limited, perhaps to 8 bits of resolution (giving 256 possible displayed values or fewer) or even only 2 values in the case of a binary display.

As a result, pixels of a full-complex holographic image are quantised for display, to a value that can be reproduced by the SLM. For example, in the extreme case of a binary SLM (such as a Digital Micromirror Device, DMD) each pixel in the display can only be in one of two states. Thus, all points on the full-complex Argand diagram need to be mapped to one of the two states. This process of quantisation reduces the image quality, visible in the perceived image as reduced contrast and/or noise.

Fourier plane filtering can be used to encode complex CGH data for display on an amplitude-only SLM. In this case the complex conjugate is added to the full complex value, to create a real value, and an additional constant term is added to create a positive real value. The conjugate and constant terms are then filtered in the Fourier plane by a spatial filter, so that the remaining components relate only to the original full complex value. However, the constant term that must be added in this method results in a significant zero-order component, which requires accurate spatial filtering, and results in a reduction in brightness.

Methods have been proposed to encode a full-complex hologram by interfering light from two elements, such as Double Phase Amplitude Coding (DPAC), but it is difficult to achieve amplitudes close to zero and achieve appropriate interference between pixels.

Accordingly, it would be desirable to improve the image quality of holographic displays.

### SUMMARY

Spatial light modulators (SLMs) can modulate light in various ways. One way is to use liquid crystals arranged in an array of elements/pixels, and these alter the polarisation state of incident light as the light passes through the element. A liquid crystal layer is birefringent, meaning that the refractive index is a function of the polarisation state of the incident light relative to the axes of the crystals. The orientation of the crystals within each element may be altered by controlling the voltage applied across electrodes of the element, which in turn applies an electric field to the liquid crystal. This voltage-controlled change in orientation of the crystals hence controls the polarisation/rotation of the light by the element. Accordingly, applying a voltage/electric field to a particular element causes an incident light ray to rotate by an angle dependent on the applied voltage/electric field. It is understood that control of the effective strength of the applied electric field may be achieved through analogue control of voltage (i.e., a high/low electric field), pulse width modulation (i.e., an applied voltage with a high/low duty cycle), or by any other means.

As well as the liquid crystal layer, an SLM may include an output polarising element (such as an output polariser) arranged after the liquid crystal layer. In some examples, the output polarising element is separate to the SLM. At some particular electric field/voltage, the polarisation state of the light after having passed through the liquid crystal layer is such that substantially all the light can be transmitted by the output polarising element. At a different electric field/voltage, the polarisation state of the light after having passed through the liquid crystal layer is such that the light is blocked/removed by the output polarising element. The amplitude of the light can therefore be controlled by controlling voltages applied to the elements of the SLM (and therefore the electric fields applied across the elements). As is known, the transformation of the light as it travels through a liquid-crystal layer can be expressed in terms of a Jones matrix characterising the liquid-crystal layer.

SLMs can be reflective or transmissive and references herein to an “SLM” are not limited to reflective or transmissive SLMs. A transmissive SLM may be configured such that light is primarily transmitted through the SLM from one side to the other. A reflective SLM may be configured such that light is primarily reflected by the SLM. Reflective SLMs contain a mirror such that light passes through the element of the liquid crystal layer, is reflected, and then passes through the element a second time in the opposite direction. Example reflective SLMs include Liquid Crystal on Silicon (LCoS) displays. For reflective SLMs, such as LCoS, where light passes through the layer twice due to the reflection, it will be understood that a Jones matrix associated with the liquid crystal layer represents the transformation after the double pass through the liquid crystal layer. As such, a Jones matrix associated with a liquid crystal layer represents the transformation of light as it passes through once in the case of a transmissive SLM or twice in the case of a reflective SLM.

Existing amplitude-modulating SLMs (that is, SLMs comprising a liquid crystal layer and an output polarising element) modulate the amplitude of light between “off” and “on” states. For example, when the light is completely blocked/filtered/deflected, the amplitude of the light may be said to be “0” (i.e., the SLM in the region of that element/pixel may be “off”). When substantially all of the light is transmitted, the amplitude of the light may be said to be “1” (i.e., the SLM in the region of that element/pixel may be “on”). Conventional SLMs therefore modulate amplitude in the range 0 to 1.

As briefly mentioned, holograms calculated in CGH are generally complex-valued, with these complex values being quantised to some discrete values to be displayed on an SLM. An ideal SLM would be capable of modulating complex values—that is, the modulation associated with each pixel/element of the SLM would be defined by Ae^{iθ}, where A is the amplitude and θ is the phase, and each element of the SLM can be used to individually control A in the range of 0 to 1 (i.e., [0, 1]), and 0 in the range of 0 to 2π (i.e., [0, 2π]).

However, unlike these ideal SLMs, commercially available SLMs generally modulate phase-only or amplitude-only. That is, a phase-only SLM applies a modulation defined by e^{iθ} for θ in the range [0, 2π], and an amplitude-only SLM applies a modulation defined by Ae^{if(A)}, for A in the range [0, 1], where f(A) is a function of amplitude. f(A) is ideally constant, but in some cases, an amplitude-only SLM may partially modulate the phase over a small range as the amplitude changes. As this phase is dependent on the amplitude, through the relation of f(A), phase is not modulated independently of amplitude.

Methods exist to encode a full-complex hologram using a phase-only or amplitude-only SLM. For example, Double Phase Amplitude Coding (DPAC) coherently interferes together two elements of a phase-only SLM, to provide a modulation proportional to e^{iθ1}+e^{iθ2} which spans a whole complex range of [0, 2π], where θ₁ is the phase introduced by the first element and θ₂ is the phase introduced by the second element. DPAC can be effective, but is very sensitive to accurate control of phase values to achieve amplitudes close to zero, and achieving appropriate interference of the two phase-only elements is difficult.

The inventors have realised that SLMs can be modified to modulate the amplitude of light in a range that spans either side of “0” (i.e., zero amplitude) when represented on an argand diagram, rather than in the range 0 to 1 (i.e., [0, 1]). A “negative” amplitude has the same intensity as the corresponding “positive” amplitude, but may be thought of as having a phase shift relative to light having the same positive amplitude, such that the negative amplitude light and positive amplitude light appear in different quadrants on an Argand diagram. Put another way, the SLM is configured so that a substantially zero output amplitude is obtained at an intermediate modulation value rather than at an end of the modulation range as is conventionally the case.

As an example, an SLM can be modified to modulate amplitude in the range [−\sqrt{0.5}, +\sqrt{0.5}] on the Argand diagram (which corresponds to an intensity modulation in the range [−0.5, +0.5]). In one particular example, the light having the negative amplitude may have a phase shift of π radians relative to the light having a positive amplitude.

The inventors have found that operating an SLM to modulate amplitude through “zero” has several benefits.

As a first benefit, the modified SLM can achieve amplitudes close to zero more accurately than existing methods (such as DPAC). For example, a single element can be operated more accurately to achieve an amplitude of 0 without having to interfere the light with light from another element.

As a second benefit, unlike the method of encoding that adds a constant value to map to positive-only amplitude, the zero-order diffraction light in the light field is much reduced (that is, the energy in the zero-order is much lower than when modulating in the range [0, 1]). This results in a hologram that has a higher image quality compared to conventional holographic displays where the zero-order light is higher in energy, and so must be removed in an additional step of spatial filtering. For example, as briefly mentioned, in many holographic displays, after the light has been modulated by the SLM, a spatial filter can be used to remove unwanted components of the light by positioning the spatial filter in a Fourier plane of the optical system. Thus, after passing from the SLM, the light is incident upon a lens, and is focused on a Fourier plane where the spatial filter is positioned. The spatial filter can physically block particular areas of the light field to remove unwanted components of the light, including the complex conjugate of the light field and the zero order of the light field. When there is a significant amount of power contained in the zero order, the filtering is often poor due to stray light and imperfect filtering. This results in a loss of image quality in the displayed hologram. By operating an SLM to modulate amplitude either side of zero amplitude, the zero order does not necessarily need to be removed, resulting in a hologram that has a higher image quality compared to the conventional holographic displays. If the zero-order is still removed, as the case may be, the filtering is much less problematic due to the lower energy in the zero-order, which again results in lower overall noise.

Accordingly, in a first aspect of the present invention, there is provided a holographic display, comprising: (i) an illumination source configured to emit at least partially coherent light, (ii) a liquid crystal layer comprising an array of elements arranged to be illuminated by the light. The liquid crystal layer is configured such that: (a) when a first electric field is applied across an element of the liquid crystal layer, the light from the element has a first polarisation state, (b) when a second electric field is applied across the element of the liquid crystal layer, the light from the element has a second polarisation state, and (c) when a third electric field is applied across the element of the liquid crystal layer, the light from the element has a third polarisation state. The display further comprises (iii) a controller configured to control electric fields applied across the elements of the liquid crystal layer, and (iv) an output polarising element. The output polarising element is configured to: (a) remove a portion of light having the first polarisation state and also transmit a portion of the light having the first polarisation state, (b) remove substantially all of the light having the second polarisation state, and (c) remove a portion of the light having the third polarisation state and also transmit a portion of the light having the third polarisation state, and wherein one of: (1) the second electric field is greater than the first electric field, and the third electric field is greater than the second electric field, and (2) the second electric field is lower than the first electric field, and the third electric field is lower than the second electric field.

In certain examples, the output polarising element is (or comprises) a transmissive polariser, and is therefore configured to remove light of a particular polarisation state by blocking the light. That is, the light does not pass through the polariser, so is removed. Similarly, the output polarising element is configured to transmit light of a particular polarisation state by allowing the light to pass through the polariser.

In other examples, the output polarising element is (or comprises) a reflective polariser, and is therefore configured to remove light of a particular polarisation state by directing/reflecting the light in a particular direction so that is not present in the displayed hologram. For example, the light may be directed towards an absorbing element of the output polarising element, which absorbs the light. Since this removed light is absorbed, it is not “transmitted” by or from the output polarising element. Similarly, the output polarising element is configured to transmit light of a particular polarisation state by directing/reflecting the light in a different direction (different to the direction of the light being removed) so that it is present in the displayed hologram. Thus, in certain examples, the output polarising element comprises a polariser and an absorbing element. Together, these remove or transmit light incident upon the output polarising element. In some examples, the absorbing element is an inner wall or cavity of the holographic display housing.

In a further example, the output polarising element is (or comprises) a prism, such as a Wollaston prism. Light passes through the prism, and is also directed in a particular direction depending on the polarisation state of the light. Such a prism is therefore configured to remove light of a particular polarisation state by directing/reflecting the light in a particular direction as it passes through the prism, so that is not present in the displayed hologram. In such a case, the light may still pass through the prism, but is blocked by an absorbing element of the output polarising element, and is not transmitted by the output polarising element. Similarly, the output polarising element is configured to transmit light of a particular polarisation state by directing/reflecting the light in a different direction (different to the direction of the light being removed) so that it is present in the displayed hologram.

In some particular examples, the electric fields are controlled by controlling a current. In general, however, the electric fields are controlled by controlling voltages applied to the elements of the liquid crystal layer. As such, in some examples, the controller is configured to control electric fields applied across the elements of the liquid crystal layer by controlling voltages applied to the elements of the liquid crystal layer. The liquid crystal layer is therefore configured such that: (a) when the element is operated at a first voltage level, the first electric field is applied across the element, (b) when the element is operated at a second voltage level, the second electric field is applied across the element, and (c) when the element is operated at a third voltage level, the third electric field is applied across the element.

Throughout this document, control of the electric fields may be described as being achieved by operating the elements at particular voltage levels. It will be appreciated however that any reference to operating or applying a voltage level to an element of the liquid crystal layer can be equally referred to as applying a particular electric field across the element.

As noted above, the electric field can be varied by analogue control of a voltage to an element, or by digital control of a voltage and adjusting the duty cycle. As such, it will be understood that when an electric field is applied across the element, this may mean a Pulse Width Modulation (PWM) electric field, where the duty cycle is varied rather than having a smoothly variable electric field. Similarly, when an electric field is greater/lower than another electric field, this may mean a PWM controlled electric field with a higher/lower duty-cycle. Thus, varying the duty cycle within a certain time period applies an average electric field for that time period, even if the instantaneous electric field is rapidly changing. The average electric field within a first time period may therefore be therefore greater or lower than an average electric field within a second time period. Most LCoS displays are digitally driven rather than analogue-driven, but this is not always the case. Accordingly, in some examples, the liquid crystal layer is therefore configured such that: (a) when the element is operated at a first duty cycle in a first time period, the first electric field is applied across the element, (b) when the element is operated at a second duty cycle in a second time period, the second electric field is applied across the element, and (c) when the element is operated at a third duty cycle in a third time period, the third electric field is applied across the element.

In some examples, the liquid crystal layer and output polarising element form at least part of an SLM. This may be the case for transmissive SLMs, for example. In other examples, the liquid crystal layer forms at least part of the SLM, and the output polarising element is separate to the SLM. This may be the case for reflective SLMs, for example. In some examples however, the output polarising element may be part of a reflective SLM. An SLM having both the liquid crystal layer and the output polarising element, means that the SLM can itself achieve amplitude modulation.

In the above aspect, when the first and third electric fields are applied across the element (such as the element is operated at the first and third voltage levels), only a portion of the total light intensity incident upon the element is transmitted by the output polarising element. The portion may be less than 80% of the total light intensity incident upon the element, or less than 70% or less than 60%. In an example, the portion of the light intensity that remains is around 50% of the total light intensity incident upon the element, which may be the case when zero amplitude is obtained at a mid point of the modulation amplitude range.

In one example, when the second electric field is greater than the first electric field, and the third electric field is greater than the second electric field: the first voltage level is a zero voltage, the second voltage level is a non-zero voltage, and the third voltage level is a non-zero voltage. As such, the second voltage level is at a voltage higher than the first voltage level, and the third voltage level is at a voltage higher than the second voltage level. The voltage (and also electric field) may therefore be said to be “increasing” as it changes from the first voltage level to the third voltage level, via the second voltage level. The first voltage level may be a minimum voltage, and the third voltage level may be a maximum voltage. When an element is operated at a zero-voltage, the element may be said to be in a quiescent state.

Alternatively, in another example, when the second electric field is lower than the first electric field, and the third electric field is lower than the second electric field: the first voltage level is a non-zero voltage, the second voltage level is a non-zero voltage, and the third voltage level is a zero voltage. As such, the second voltage level is at a voltage lower than the first voltage level, and the third voltage level is at a voltage lower than the second voltage level. The voltage (and also electric field) may therefore be said to be “decreasing” as it changes from the first voltage level to the third voltage level, via the second voltage level. The third voltage level may be a minimum voltage, and the first voltage level may be a maximum voltage.

In some examples, the first voltage may be known as an initial voltage, the third voltage may be known as a final voltage, and the second voltage may be known as an intermediate voltage.

In some examples, when the first electric field is applied across the element, the light has a first phase, when the third electric field is applied across the element, the light has a second phase, and the first phase and the second phase are located in different quadrants on an Argand diagram. Accordingly, the light that is transmitted by/through the output polarising element at the first voltage level has a phase in a first quadrant of the Argand diagram, and the light that is transmitted by the output polarising element at the third voltage level has a phase in a second quadrant of the Argand diagram, where the first and second quadrants are different.

The liquid crystal layer and output polarising element are therefore configured such that as the voltage is changed (increased or decreased) from the first level to the third level, via the second (intermediate) level, the amplitude of the light varies from a first quadrant of the argand diagram (such as a “positive” or “negative” amplitude) to a second quadrant of the argand diagram (such as a “negative” or “positive” amplitude), via a zero amplitude. A viewer would see the light changing from on to off to on again, as the voltage applied to the element is changed. This is different to conventional amplitude-modulating SLMs which operate such that as the voltage is increased (or decreased) from a first level to a third level, via a second level, the amplitude of the light varies in the range of [0, 1]. A viewer of the conventional SLM would see the light changing from off to on at varying levels of brightness, as the voltage applied to the element is changed.

In an example, the output polarising element is arranged such that when the applied voltage is equal to the first voltage level, the light has a maximum amplitude, and increasing or decreasing the voltage towards the second voltage level decreases the amplitude. At the second voltage level, the amplitude of the light is zero (i.e., substantially no light is transmitted from the output polarising element) and continuing to increase or decrease the voltage towards the third voltage level increases the amplitude of the light to its maximum again.

In some examples, the amplitude of the transmitted light may be “mirrored” either side of zero. So, for example, if a light ray having specific amplitude is desired to generate a holographic image, one of two voltages can be applied to the element, and of these two voltages, the actual voltage selected depends upon the phase modulation required.

In some examples, the holographic display is configured such that the light from a first element is not interfered with light from a second element. Thus, the desired amplitude and/or phase of light from an element is achieved without needing to interfere light from two or more elements of the liquid crystal layer. Accordingly, light from the element is transmitted to an observer/viewer without interfering with light from another element (such as light from adjacent or a neighbouring element).

In some examples, the controller is further configured to control the illumination source. In one example, the controller may control a brightness/intensity of the illumination source so that the amplitude depends on the operation of both the illumination source and the liquid crystal layer.

In some arrangements, when the second electric field is applied across the element of the liquid crystal, the polarisation state of the light is adjusted relative to the first polarisation state. Similarly, when the third electric field is applied across the element, the polarisation state of the light is adjusted relative to second polarisation state. Accordingly, in some examples, the first, second and third polarisation states are different.

In an example, the polarisation state of the light is adjusted by the element when the first electric field is applied, relative to an initial polarisation state of the light incident upon the element. In another example, the polarisation state is unchanged when the first electric field is applied, relative to an initial polarisation state of the light incident upon the element.

As mentioned, a liquid crystal layer may comprise a plurality of elements/pixels, such as an array of elements. An element may correspond to a pixel or a sub-pixel (such as a sub-pixel of an RGB pixel).

The illumination source may comprise a single light emitter or a plurality of light emitters and has an illumination area sufficient to illuminate the liquid crystal layer.

In certain examples, there is a single output polarising element that receives light from the entire area of the liquid crystal layer. In other examples there a plurality of output polarising elements that receive light from one or more elements of the liquid crystal layer. In a specific example, there is a separate output polarising element for each element of the liquid crystal layer.

In an example, the illumination source, the liquid crystal layer and the output polarising element are arranged along an optical axis/path. Being arranged along the optical axis ensures that the light in the display can be transmitted through each component of the display. The output polarising element is therefore arranged such that light passes from the liquid crystal layer and is incident upon the output polarising element. The output polarising element may therefore be said to be positioned “after” the liquid crystal layer in terms of an optical path starting from the illumination source. The liquid crystal layer may sometimes be physically arranged between the illumination source and the output polarising element.

In some examples, there may further be an input polarising element (also known as an input polariser) arranged “before” the liquid crystal layer in terms of an optical path starting from the illumination source, to polarise the light incident upon the liquid crystal layer. The input polarising element may therefore be arranged between the illumination source and the liquid crystal layer. The input polarising element may also be arranged on the optical axis of the holographic display. In other examples, the illumination source is itself configured to output polarised light so that the input polarising element may be omitted. An input polarising element may still be used with polarised illumination sources, for example to change the polarisation to one best suited to the characteristics of the liquid crystal layer.

In some examples, the output polarising element is arranged at a particular angle relative to the initial polarisation of the light that is incident upon the liquid crystal layer. The angle may be predetermined, in some examples. The angle of the output polarising element relative to the polarisation states of the light can enable the SLM to achieve the modulation “through zero”.

In more general terms, the relationship between the output polarising element, the initial polarisation state of the light incident upon the liquid crystal layer, and the liquid crystal layer itself may be defined in terms of Jones matrices and vectors. The specific matrices/vectors can therefore be configured to achieve the modulation through zero.

As briefly mentioned above, the “behaviour” (i.e., transformation) of light as it passes through a liquid crystal layer can be expressed in terms of a Jones matrix and a Jones vector. A liquid crystal layer (and therefore each element of the liquid crystal layer) is associated with a Jones matrix, which can be determined. The Jones matrix for each element is a function of the electric field applied to the element. Similarly, a polarisation state of the light is described in terms of a Jones vector, and an output polarising element can also be described in terms of a Jones vector. Thus, the rotation/polarisation change through an element of the liquid crystal layer can be quantified mathematically, and the transmission through the output polarising element can be predicted. It may be useful to determine the Jones matrix of a liquid crystal layer such that the specific voltages and/or the output polarising element can be determined, so that the SLM can be appropriately configured to modulate light through zero.

Accordingly, light incident upon the element of the liquid crystal layer has an initial polarisation associated with a first Jones vector, the output polarising element is associated with a second Jones vector, the element of the liquid crystal layer is associated with a Jones matrix, wherein the Jones matrix for the element is a function of the electric field applied to the element, and the second Jones vector is based on the Jones matrix and the first Jones vector. In a specific example, the second Jones vector can be adjusted by adjusting the angle of the output polarising element relative to the initial polarisation state of the light incident upon the liquid crystal layer.

In examples, light incident upon the element of the liquid crystal layer is linearly polarised and the output polarising element comprises a linear output polariser. The incident light may be polarised using a linear input polarising element.

In one particular example in which the light is linearly polarised, the liquid crystal layer is an In-Plane Switching (IPS) based liquid crystal layer. In such IPS liquid crystal layers, the liquid crystals remain in a plane defined by the liquid crystal layer and rotate within that plane as different electric fields/voltages are applied. Accordingly, the liquid crystal layer may comprise liquid crystals that are configured to align parallel to a plane of the liquid crystal layer when the first, second and third electric fields are applied across the element (i.e., when the element is operated at the first voltage level, the second voltage level and the third voltage level). Such liquid crystal layers may be associated with a Jones matrix that is approximately proportional to a real matrix.

It will be appreciated that the terms “parallel” and “perpendicular” in reference to alignment of liquid crystals are to be understood as being “approximately parallel” and “approximately perpendicular”. The skilled person understands that a typical liquid crystal layer will have liquid crystals that are not perfectly parallel or perpendicular to a plane defined by the liquid crystal layer. Furthermore, liquid crystals that are aligned parallel to a plane means that the axes defined by each liquid crystal are in the plane, rather than perpendicular to the plane.

In a particular arrangement, the output polarising element is orientated the same as the incident polarisation orientation. Accordingly, the light incident upon the liquid crystal layer has a polarisation state, and the output polarising element is orientated to transmit substantially all light having the particular polarisation state. In a particular example, this allows use of a reflective SLM, and the light is therefore passed through the polarising element on both input and output paths. The output polarising element can therefore also act as an input polarising element. Accordingly, the liquid crystal layer may form at least part of a reflective spatial light modulator, SLM, and the light is configured to pass through the output polarising element, both: (i) before being incident upon the element of the liquid crystal layer, and (ii) after passing through the element of the liquid crystal layer. The light therefore passes through the output polarising element in a first direction before being incident upon the element, and passes through the output polarising element in a second direction after passing through the element, where the first and second directions are opposite to each other. Because the input and output polarisation orientations are the same, the output polarising element can be part of the reflective SLM (i.e., because the incident light is able to pass through the output polariser without being altered).

In another example in which the light is linearly polarised, the liquid crystal layer is a Twisted Nematic (TN) based liquid crystal layer. In a TN liquid crystal layer, the liquid crystals are parallel to a plane defined by the liquid crystal layer when a zero voltage is applied and rotate away from that plane as different electric fields/voltages are applied. Accordingly, the liquid crystal layer may comprise liquid crystals that are configured to: (i) align parallel to a plane of the liquid crystal layer when the electric field applied across the element is zero (i.e., operated at a zero voltage level), and (ii) rotate away from the plane (towards being perpendicular to the plane) when the electric field applied across the element is non-zero (i.e., when operated at non-zero voltage levels).

In alternative examples, light incident upon the element of the liquid crystal layer is circularly polarised and the output polarising element comprises a linear output polariser. The incident light may be polarised using a circular input polarising element, such as a waveplate (more generally referred to as a polarisation modifying element).

In a particular example in which the light is circularly polarised, the liquid crystal layer is a Vertically Aligned (VA) based liquid crystal layer. In such VA liquid crystal layers, the liquid crystals are perpendicular to a plane defined by the liquid crystal layer when a zero voltage is applied and rotate towards that plane as different electric fields/voltages are applied. Accordingly, the liquid crystal layer may comprise liquid crystals that are configured to: (i) align perpendicular to a plane of the liquid crystal layer when the electric field applied across the element is zero (i.e., operated at a zero voltage level), and (ii) rotate towards the plane when the electric field applied across the element is non-zero (i.e., when operated at non-zero voltage levels).

In a further example in which the light is circularly polarised, the liquid crystal layer is a Twisted Nematic (TN) based liquid crystal layer. As noted earlier, a TN liquid crystal layer, the liquid crystals are parallel to a plane defined by the liquid crystal layer when a zero voltage is applied and rotate away from that plane as different electric fields/voltages are applied. Accordingly, the liquid crystal layer may comprise liquid crystals that are configured to: (i) align parallel to a plane of the liquid crystal layer when the electric field applied across the element is zero (i.e., operated at a zero voltage level), and (ii) rotate away from the plane (towards being perpendicular to the plane) when the electric field applied across the element is non-zero (i.e., when operated at non-zero voltage levels). Both VA and TN liquid crystal layers may be associated with a Jones matrix having complex terms.

In some examples, the display further comprises a beam splitter. In a particular example, the display comprises a polarising beam splitter. As such, the polarising beam splitter may comprise the output polarising element. The polarising beam splitter can therefore act as an input polarising element and an output polarising element. As briefly mentioned, SLMs can be reflective and beam splitters may be useful in displays where the liquid crystal layer forms at least part of a reflective SLM. In some cases, the display further comprises a polarisation modifying element, such as a waveguide. Light from the polarising beam splitter passes through the polarisation modifying element and is incident upon the liquid crystal layer. After passing through the liquid crystal layer and reflecting, the light can pass through the polarisation modifying element a second time, in the opposite direction. Similarly, the light is again incident upon the polarising beam splitter. The polarisation modifying element can therefore modify the polarisation state of the light both before the light is incident upon the element, and after it has passed through the element. The polarisation modifying element is therefore located between the output polarising element and the liquid crystal layer along an optical axis/path. The polarisation modifying element can be selected so that when the second electric field is applied across the element of the liquid crystal layer, the polarisation state of the light after passing through the polarisation modifying element is such that substantially all of the light is removed/blocked by the polarising beam splitter.

As such, in an example, the display further comprises a polarisation modifying element arranged between the output polarising element and the liquid crystal layer, the polarisation modifying element being configured to modify a polarisation state of light, and a polarising beam splitter comprising the output polarising element and configured to remove substantially all of the light having the second polarisation state, p. The liquid crystal layer forms at least part of a reflective SLM and the element of the liquid crystal layer is associated with a Jones matrix, J(B), where the Jones matrix for the element is a function of the electric field, B, applied to the element. The polarisation modifying element is associated with a Jones matrix, R, and RJ(B′)Rp=p, where J(B′) is the Jones matrix associated with the element of the liquid crystal layer at the second electric field, B′. Accordingly, the polarisation modifying element is chosen such that RJ(B′)Rp=p.

As such, when the light has the second polarisation state p (which is the same as the incident polarisation state), the light returns back along the incident path—the remaining light that is transmitted to the viewer is the component of the reflected light that is orthogonal to p (which is nothing when the light has the second polarisation state). By configuring the display in this way, such that the outgoing polarisation is orthogonal to the incident polarisation, a polarising beam splitter can be used to separate incident and outgoing paths, resulting in much higher optical efficiency.

In a particular case, the polarisation modifying element is a waveplate having half the retardance of J(B′) and a slow axis aligned to a fast axis of J(B′). J(B) may be described by a pure retardance.

As discussed, after the light has been modulated using the liquid crystal layer and output polarising element, the light may be filtered to improve image quality. Accordingly, in some examples, the holographic display further comprises: (i) a lens arranged to receive light from the output polarising element and configured to generate a Fourier transform, F(H), of a target light field at a Focal plane of the lens, and (ii) a spatial filter positioned at the Focal plane and configured to remove a Fourier transform of a complex conjugate of target light field, F(H*). In some examples, the spatial filter is further configured to remove a zero-order of the target light field. As mentioned, because of the amplitude modulation scheme “through zero”, the energy in the zero-order is much lower than in conventional systems. This means that the effect of any imperfect filtering of this zero-order will be significantly less severe than an SLM that modulates in the range [0,1].

In some examples, the spatial filter is configured to remove the Fourier transform of complex conjugate of target light field, F(H*) without filtering a zero order of the target light field. Thus, as mentioned, due to the SLM being configured to modulate amplitude in a range spanning zero, the amount of power contained in the zero order is small, and so no filtering is required, resulting in a higher image quality. The filter may be configured to allow the zero order of the target light field to pass through.

In some examples, the lens has a focal length and the SLM and the lens are spaced apart by a distance equal to the focal length of the lens. In some examples, the lens and SLM are spaced apart by a distance that is greater or less than the focal length. In such cases, the converging/diverging light can be collimated using additional optics further along the optical path. It may be desirable to space the lens and SLM apart by the focal length to provide a more compact display (since the additional optics can be omitted).

In one example, the Focal plane of the lens and the lens are spaced apart by a distance equal to the focal length of the lens. Thus, the lens and filter are spaced apart by a distance equal to the focal length of the lens.

The filter can physically block a portion of the light received from the lens, such as the portion containing the Fourier transform of complex conjugate of target light field, F(H*).

According to a second aspect of the present invention, there is provided a method of modulating an amplitude of light in a holographic display, comprising: (i) operating an illumination source to emit at least partially coherent light towards an element of a liquid crystal layer, (ii) applying a first electric field across the element, such that the light from the element has a first polarisation state, (iii) applying a second electric field across the element, such that the light from the element has a second polarisation state, (iv) applying a third electric field across the element, such that the light from the element has a third polarisation state, (v) using an output polarisation element, removing a portion of the light having the first polarisation state and transmitting a portion of the light having the first polarisation state, (vi) using the output polarisation element, to remove substantially all of the light having the second polarisation state, and (vii) using the output polarisation element, removing a portion of the light having the third polarisation state and transmitting a portion of the light having the third polarisation state, wherein one of: (1) the second electric field is greater than the first electric field, and the third electric field is greater than the second electric field, and (2) the second electric field is lower than the first electric field, and the third electric field is lower than the second electric field.

In some examples, applying the first electric field across the element comprises operating the element at a first voltage level, applying the second electric field across the element comprises operating the element at a second voltage level, and applying the third electric field across the element comprises operating the element at a third voltage level.

In some examples, the method further comprises: (i) determining a Jones matrix of the liquid crystal layer, and (ii) determining the angle based on: the Jones matrix and the initial polarisation of the light.

In some examples, the method further comprises: (i) passing the light representative of a target light field, H, of the hologram, through a lens to generate a Fourier transform, F(H), of a target light field at a focal plane of the lens, and (ii) passing the light through a spatial filter positioned at the focal plane to remove a Fourier transform of complex conjugate of target light field, F(H*). In some examples, passing the light through the spatial filter comprises filtering a zero order of the target light field. In other examples, passing the light through the spatial filter comprises passing the light through the spatial filter without filtering a zero order of the target light field.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagrammatic representation of an example holographic display according to an embodiment;

FIG. 2 is a schematic diagram of the holographic display of FIG. 1;

FIG. 3 is an Argand diagram showing the range of phase and amplitude modulation using a holographic display of a first embodiment;

FIG. 4 is a schematic diagram of another holographic display, according to an example;

FIG. 5 is an Argand diagram showing the range of phase and amplitude modulation using a holographic display of a second embodiment; and

FIG. 6 is a schematic diagram of a holographic display including a lens and filter.

### DETAILED DESCRIPTION

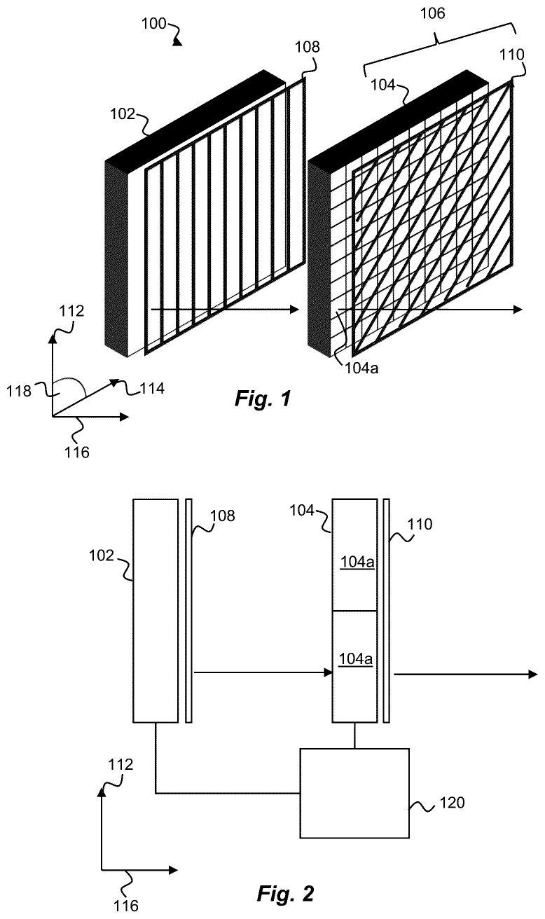

FIGS. 1 and 2 depict a system 100 forming at least part of a holographic display according to an example. The system 100 includes an illumination source 102 configured to emit at least partially coherent light. In this example, the illumination source 102 is a single light emitter that emits light rays towards a liquid crystal layer 104 of an SLM 106. In other examples, the illumination source 102 comprises a plurality of light emitters which together illuminate the liquid crystal layer 104. Examples using a plurality of light emitters may also have the ability to control light emitters individually or by region, enabling reduced power consumption and/or increased contrast. In this example, the illumination source 102 is controlled to emit Red, Green or Blue light using time division multiplexing. Other examples may use an illumination source 102 that emits light having a single wavelength or light having wavelengths within a range of a single wavelength.

Light rays, emitted by the illumination source 102, travel at least from the illumination source 102 to the liquid crystal layer 104. The light rays follow an optical path along an optical axis 116, from the illumination source 102 towards the eyes of an observer that is viewing the holographic display.

The liquid crystal layer 104 comprises an array of pixels/elements 104a. A voltage/bias can be applied to each element 104a individually to control the electric field applied across the elements 104a. The presence of the electric field causes a rotation of the liquid crystals and therefore may alter the polarisation state of light as it passes through the element 104a.

The SLM 106 of this example further comprises an output polarising element 110 positioned after the liquid crystal layer 104 along the optical path.

Although in this example the SLM 106 comprises both the liquid crystal layer 104 and the output polarising element 110, in other examples, the SLM 106 may not comprise the output polarising element 110. The output polarising element 110 may then be separate to the SLM 106.

Light rays, emitted by the illumination source 102, therefore travel through the liquid crystal layer 104 and are incident upon the output polarising element 110 along the optical path. Depending upon the polarisation of the light as it reaches the output polarising element 110 (which can be influenced by the voltage applied to the particular element 104a), the light may be blocked, or may partially pass through the output polarising element 110.

In FIGS. 1 and 2, the output polarising element 110 is shown as being a transmissive polariser, in which the polariser itself can absorb at least a portion of the light incident upon it (and/or allow at least a portion of the light to pass through). It will be appreciated that the same concepts are applicable to other types of polarisers also. In some examples, the output polarising element 110 comprises a polarising element and an absorbing element, where the absorbing element absorbs light reflected from and/or transmitted through the polarising element. For example, the polarising element may be a reflective polariser that separates light into two separate beams and directs “unwanted” light towards an absorbing element. Regardless of the type, the output polarising element 110 is configured to either: (i) remove a portion of light having a particular polarisation state (such as a first or third polarisation state) and also transmit a portion of the light having the particular polarisation state, or (ii) remove substantially all of the light having a different polarisation state (such as a second polarisation state). In this example, the output polarising element 110 is a linear polariser. The output polarising element 110, is positioned after the liquid crystal layer 104 along the optical path taken by the light.

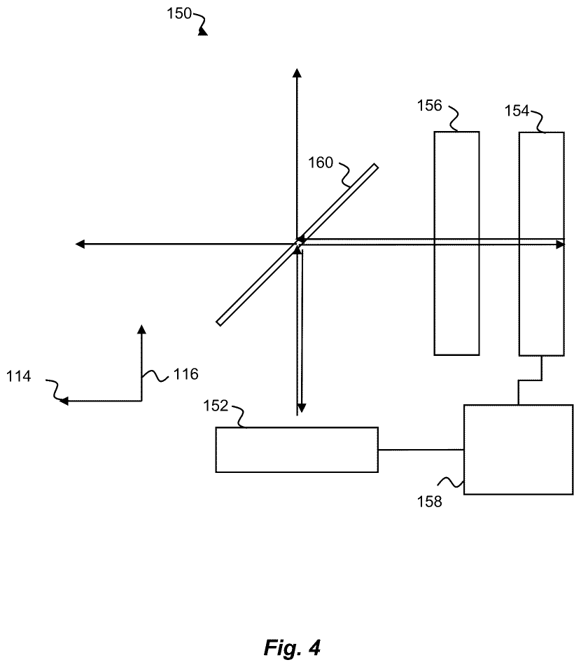

Similarly, in FIGS. 1 and 2, the SLM 106 is shown as being transmissive such that the light enters one side of the layer (such as the front side) and passes out of a different side of the layer (such as a rear side). Again, it will be appreciated that the same concepts are applicable to other types of SLM too. For example, the SLM may be a reflective liquid crystal layer, such that the light enters and passes out of the same side it entered (such as the front side). As noted earlier, in cases where the SLM is reflective, the output polarising element 110 may generally not be considered as part of the SLM. An example reflective SLM is discussed later and is illustrated in FIG. 4.

The output polarising element 110, together with the liquid crystal layer 104, therefore modulate the amplitude of light rays from the liquid crystal layer 104. For example, if a light ray that is linearly polarised along a vertical axis 112 is traveling in a direction along the optical axis 116 (and therefore has a particular Jones vector), and is incident upon a vertically orientated output polarising element (again, having a particular Jones vector), the light ray transmitted by the output polarising element 110 may have substantially 100% of its initial intensity (i.e., the amplitude of the transmitted light ray is unchanged and/or is at maximum). Such a vertically orientated output polarising element may be said to be aligned with the linearly polarised light ray and is therefore arranged an angle of 0 radians relative to the linearly polarised light ray incident upon the output polarising element. Conversely, if a light ray is linearly polarised along the horizontal axis 114 and is incident upon a vertically orientated output polarising element, the light ray may have substantially 0% of its initial intensity after interacting with the output polarising element (i.e., the amplitude of the transmitted light ray is at a minimum, or zero). Such a vertically orientated output polarising element may be said to be “crossed” with the horizontally polarised light ray and is therefore arranged an angle of π/2 radians relative to the linearly polarised light ray incident upon the output polarising element. When substantially all of the light incident upon the output polarising element is blocked/removed by the output polarising element, the output polarising element may be said to remove substantially all of the light having a particular polarisation state.

In another example, if a light ray that is linearly polarised along a vertical axis 112 is traveling in a direction along the optical axis 116, and is incident upon an output polarising element that is arranged at an angle of π/4 radians relative to the vertical axis 112, the light ray may have approximately 50% (i.e., 0.5) of its initial intensity after interacting with the output polarising element (i.e., the amplitude of the transmitted light ray is \sqrt{0.5}). Such an orientated output polarising element is therefore arranged an angle of π/4 radians relative to the linearly polarised light ray incident upon the output polarising element. When a portion (such as 50% of the light intensity) is transmitted by the output polariser, the output polarising element may be said to remove a portion of light having a particular polarisation state and also transmit a portion of the light having the particular polarisation state. The removed portion may be absorbed by the polarising element, or an absorbing element, for example.

In some examples, the system 100 comprises an input polarising element 108 arranged between the illumination source 102 and the liquid crystal layer 104. An input polarising element 108 can polarise light such that the polarised light is incident upon the liquid crystal layer 104. In some examples the input polarising element 108 is omitted if the light emitted by the illumination source 102 is already polarised in the desired way. In some examples, the input polarising element 108 is a linear polariser (as depicted in FIG. 1), but in other examples, the input polarising element 108 is a different type of polariser, such as a circular polariser.

FIG. 2 depicts a controller 120 that can control the electric fields/voltages applied to each element of the liquid crystal layer 104 to provide full control over the amplitude (and possibly phase) modulation of light output by the system 100. The controller 120 may also control operation of the illumination source 102.

FIGS. 1 and 2 also depict a linear arrangement of the holographic display but other arrangements may include image folding components. For example, a folded optical path may be provided.

As discussed, the inventors have realised that an optical system can be configured such that when an element 104a is controlled at particular voltage levels, it is possible to modulate the amplitude of light “through zero” as the voltage is increased or decreased.

To illustrate this more clearly, several embodiments will be discussed in turn.

### In-Plane Switching (IPS) Based Liquid Crystal Layer

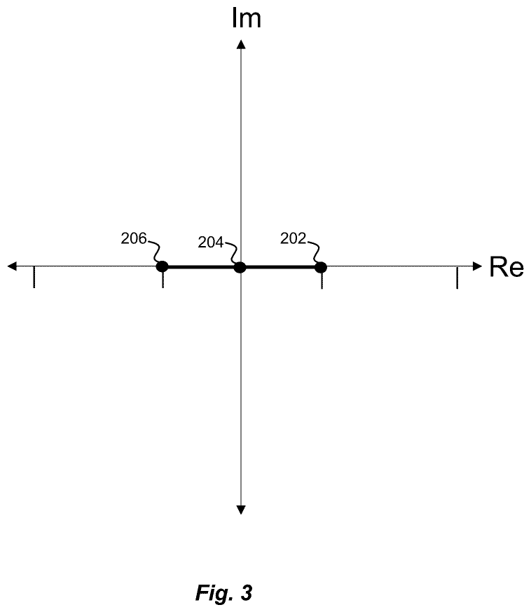

In a first embodiment, the liquid crystal layer 104 is an In-Plane Switching (IPS) based liquid crystal layer 104. FIG. 3 depicts an example Argand/phasor diagram for an example system comprising the IPS based liquid crystal layer 104. The phasor diagram represents the amplitude and phase of light after interaction with the output polarising element 110. The amplitude of a light ray after interaction with the output polarising element 110 is given by the magnitude of the value on the real axis (Re). The sign of the amplitude corresponds to the sign of the real part of the complex number projected on the real axis. The phase of the light ray is given by the azimuthal angle between the positive real axis and the position of a point on the diagram. The location of a point on the phasor diagram can be adjusted by controlling the voltage(s) applied to an element 104a of the liquid crystal layer 104.

As mentioned, the phasor diagram of FIG. 3 is representative of an example system comprising the IPS based liquid crystal layer 104, a particular polarisation of light incident upon the layer 104, and a particular orientation of the output polarising element 110. In this case, the light incident upon the liquid crystal layer 104 is linearly polarised, and the output polarising element 110 comprises a linear polariser.

An IPS based liquid crystal layer 104 may be characterised as having a Jones matrix comprising only real terms, or having a Jones matrix that is approximately proportional to a real matrix. In more general terms, IPS liquid crystal layers 104 comprise liquid crystal molecules that are: (i) aligned parallel to the layer/display (in-plane), and (ii) reoriented (as a result of the applied voltage) while remaining essentially parallel to the layer. For example, in absence of an applied voltage, the liquid crystals may be aligned parallel to the plane of the layer 104, and in the presence of an applied voltage, the liquid crystals remain parallel to the plane of the layer 104, but at different respective orientations about an axis that is perpendicular to the plane of the layer. With regard to FIG. 1, a longitudinal axis of a liquid crystal may be aligned in plane defined by axes 112 and 114, and thus rotate about the optical axis 116. The optical axis 116 is therefore perpendicular to a plane defined by the liquid crystal layer 104.

In one particular example, the liquid crystal layer 104 has a Jones matrix given by a rotation matrix approximately proportional to:

$$( \begin{matrix}{cos ( φ )}^{2} - {sin ( φ )}^{2} & \pm 2 sin ( φ ) cos ( φ ) \\ \pm 2 sin ( φ ) cos ( φ ) & {sin ( φ )}^{2} - {cos ( φ )}^{2}\end{matrix} )$$

Where angle, φ is the fast axis orientation angle measured with respect to the orientation in the quiescent state, and is a function of the applied voltage to the particular element of the liquid crystal layer 104. In this particular example, φ is in the range [0, π/4]. This particular Jones matrix is a model describing a half wave plate rotated at an angle φ from its orientation in the quiescent state. For example, linear light polarised light at an angle θ (measured from the orientation of the fast axis of the liquid crystal in the quiescent state) will be transformed to linearly polarised light at an angle 2π−θ, so if θ is set to be 0 then the liquid crystal layer 104 can therefore rotate the polarisation of light in the range [0, π/2], where the rotation angle of the polarised light is twice the fast axis orientation angle.

It will be appreciated that the Jones matrix representation above (and any other example representations discussed herein) are approximate models, which are used to inform the candidate polariser configurations, rather than exact descriptions of a real liquid crystal layer. The examples have been found to be a sufficiently accurate models for that purpose, but are idealised representations.

In a similar way, a polarisation state of light can be represented by a Jones vector and the particular orientation/configuration of the output polarising element can be represented by a Jones vector. Light incident upon the liquid crystal layer 104 may therefore have a first Jones vector, and the output polarising element 110 may have a second Jones vector.

It can therefore be shown that for linearly polarised light (that is incident upon the IPS liquid crystal layer 104), applying a voltage to a particular element 104a of the liquid crystal layer 104 causes a pure rotation of the polarisation state of the light by an angle of 2φ. The incident light may be linearly polarised by a linear input polarising element 108, for example.

In this example system, the output polarising element 110 is arranged at a specific angle 118 relative to the initial polarisation of the light, such that as the voltage applied to an element 104a is increased, the amplitude of the light passes through zero. For any particular type of liquid crystal layer 104, this can be achieved by selecting an appropriate angle 118 and an initial polarisation. The orientation angle 118 of the output polarising element 110 may be defined as an angle extending around the optical axis 116 (relative to a reference point, such as the vertical axis 112). The inherent properties of the output polarising element 110 and the angle 118 are represented by the Jones vector of the output polarising element 110.

At a first point in time, a first voltage level is applied to an element 104a. In this example, the first voltage level is zero (or 0V). The element 104a is accordingly in a quiescent state because there is no electric field applied to the liquid crystals in the element 104a. In this case, when the element is in its quiescent state, φ=0. Light passing through the element has a first polarisation state (which may be unchanged from its initial polarisation state). As mentioned above, the linearly polarised light, the voltage level and the angle 118 relative to the initial polarisation, are such that the intensity of light is attenuated by around 50% by the output polarising element 110 (thus, a portion of light is removed and a portion of light is transmitted). This can be achieved by orientating the polariser 110 at an angle of π/4 radians relative to the polarisation state of the linearly polarised light ray that has passed through the element 104a. More generally, the output polariser 110 may be arranged at an angle between π/8 radians and 3π/8 radians (although this would affect the intensity of light that is attenuated).

Due to the initial polarisation (characterised by the first Jones vector), and the type of liquid crystal layer 104 (characterised by the Jones matrix), it can be shown that at such a voltage level, the light does not undergo a phase modulation. The light is therefore represented on the phasor diagram by point 202, where the light has 50% of its initial, incident intensity (an amplitude of +\sqrt{0.5}, as shown in FIG. 3) and no phase modulation.

Later, if the voltage is increased from the first voltage level (in this case 0V), to a second (higher, non-zero) voltage level, the linearly polarised light is rotated within the element 104a. The light passing through the element 104a therefore has a second polarisation state, different to when the element 104a was operated at the first voltage level. In this case, φ=π/8 radians. This rotation increases the angle between the output polarising element 110 and the light. At this second voltage level the angle between the output polarising element 110 and the light ray may be approximately π/2 radians such that the light ray having the second polarisation state is blocked/absorbed by the output polarising element 110 and therefore has an amplitude of approximately zero. For example, at the second voltage, the light ray passing through the element 104a may have rotated by π/4 radians relative to the light ray in the quiescent state and therefore be perpendicular to the polariser 110 such that an angle of π/2 radians is subtended between the light ray and the polariser 110. The light is therefore represented on the phasor diagram by point 204, where the light has approximately 0% of its incident intensity and amplitude (shown by its location at the origin of the Argand diagram in FIG. 3).

Later still, if the applied voltage continues to be increased from the second voltage level to a third (higher, non-zero) voltage level (which may be a maximum voltage), the light is rotated further and has a third polarisation state, different to the second polarisation state. In this case, φ=π/4 radians. This rotation further increases the angle between the output polarising element 110 and the light. At this third voltage the angle between the output polarising element 110 and the light ray may be approximately 3π/4 radians such that the output light again has an intensity of approximately 50% of its maximum intensity (thus, a portion of light is removed and a portion of light is transmitted). For example, at the third voltage level, the light passing through the element 104a may have rotated by π/4 radians relative to the light ray at the second voltage level and therefore π/2 radians relative to the light ray in the quiescent state. Due to the extent of the rotation beyond π/2 radians, the light is represented in a different quadrant on the phasor diagram. This is effectively represented as light having a “negative” amplitude. Accordingly, the light is represented on the phasor diagram by point 206, where the light has approximately 50% of its maximum intensity (an amplitude of −\sqrt{0.5}, as shown in FIG. 3) and an effective phase modulation of π radians.

FIG. 3 therefore illustrates how the amplitude of light can be modulated through zero by arranging an output polarising element 110 at a specific angle 118 such that as the voltage applied to an element is increased from a first voltage level to a third voltage level via a second voltage level, the intensity decreases from a particular level to zero and then increases again. The zero amplitude is achieved at this second, intermediate voltage level. As discussed, this is achieved by having a linear input polarisation state aligned to the quiescent orientation of the liquid crystals (i.e., the first Jones vector may be (1, 0)), and a linear output polarising element at π/4 radians to the input polarisation (i.e., the second Jones vector may be (1, −1; −1, 1)).

In summary, in this embodiment, the light incident upon the liquid crystal layer has a linear polarisation (in any orientation), and the linear output polariser is orthogonal to the light from the liquid crystal layer at an intermediate value of φ (e.g. at φ=π/8). This modulates the output amplitude according to sin(2(φ−π/8)), achieving pure amplitude modulation in the range [−\sqrt{0.5}, +\sqrt{0.5}]. A particular example has an output polariser which matches the input polarisation state, meaning that the polariser can be part of a reflective SLM, and light is passed through both on input and output paths. For example, an input orientation of (cos(−π/8), sin(−π/8)) will be transformed to (cos(3π/8), sin(3π/8)) when φ=π/8, which is orthogonal to an output polariser passing (cos(−π/8), sin(−π/8)).

It will be appreciated that the same effect can be achieved when the voltage is decreased from a first voltage level to a third voltage level. For example, the first voltage level may be a maximum voltage level, and it is decreased to a third, zero voltage level, via a second intermediate voltage level.

In a variation of the above embodiment, φ is in the range [0, π/2] for a custom IPS based liquid crystal layer. This may be achieved by driving an IPS based liquid crystal layer with greater electric field to achieve more rotation. In this variation, the light incident upon the liquid crystal layer has a linear polarisation (in any orientation), and the linear output polariser is orthogonal to the light from the liquid crystal layer at an intermediate value of φ (e.g. at (=π/4). This modulates the output amplitude according to sin(2(φ−π/4)), achieving pure amplitude modulation in the range [−1, +1]. As such, by reference to the Argand diagram of FIG. 3, the amplitude at point 202 is +1, the amplitude at point 204 is 0, and the amplitude at point 206 is −1. Another example has an output polariser which matches the input polarisation state, meaning that the polariser can be part of a reflective SLM, and light is passed through both on input and output paths. For example, an input orientation of (1, 0) will be transformed to (0, 1) when φ=π/4, which is orthogonal to an output polariser passing (1, 0).

### Twisted Nematic (TN) Based Liquid Crystal Layer

FIG. 3 is also representative of an example system 100, where the liquid crystal layer 104 is a TN based liquid crystal layer 104. As with the first embodiment discussing IPS based liquid crystal layers, in this second embodiment, the light incident upon the liquid crystal layer 104 is linearly polarised (for example, has a Jones vector of (1, 0)) and the output polarising element 110 is arranged at an angle of π/4 radians relative to the reference axis 112.

A TN based liquid crystal layer 104 may be characterised as having liquid crystal molecules that are: (i) aligned parallel to a plane defined by the liquid crystal layer 104 in absence of an applied electric field/voltage (when the electric field/voltage is zero), and (ii) reoriented (as a result of a non-zero electric field/voltage being applied) away from the plane. Reorientating away from the plane may be referred to as rotating towards being perpendicular to the plane.

In one particular example, the liquid crystal layer 104 has a Jones matrix given by a rotation matrix approximately proportional to:

$$( \begin{matrix}cos ( φ ) & sin ( φ ) \\ - sin ( φ ) & cos ( φ )\end{matrix} )$$

As for the IPS based liquid crystal layer variation discussed above, φ is in the range [0, π/2], and φ=0 when an element of liquid crystal layer is in a quiescent state, and φ=π/2 when the electric field applied to the element is at a maximum. In this embodiment, the light incident upon the liquid crystal layer has a linear polarisation (in any orientation), and the linear output polariser is arranged at π/4 degrees relative to the input polarisation. This modulates the output amplitude according to (cos φ-sin φ)/\sqrt{2}, achieving pure amplitude modulation in the range [−\sqrt{0.5}, +\sqrt{0.5}]. As such, by reference to the Argand diagram of FIG. 3, the amplitude at point 202 is +\sqrt{0.5}, the amplitude at point 204 is 0, and the amplitude at point 206 is −\sqrt{0.5}.

### Reflective SLM

FIG. 4 depicts a schematic diagram of another system 150 forming at least part of a holographic display according to an example. The system 150 includes an illumination source 152 configured to emit at least partially coherent light. The illumination source 152 may correspond to the illumination source 102 discussed earlier. Light rays, emitted by the illumination source 152, travel at least from the illumination source 152 to a liquid crystal layer 154. The light rays follow a non-linear optical path, from the illumination source 152 towards the eyes of an observer that is viewing the holographic display.

The liquid crystal layer 154 comprises an array of pixels/elements. In contrast to the example of FIGS. 1 and 2, the liquid crystal layer 154 is reflective, such that light passes through the liquid crystal layer 154 a first time, reflects, and then passes through the liquid crystal layer 154 a second time. As discussed, a voltage/bias can be applied to each element individually to control the electric field applied across the elements. The presence of the electric field causes a rotation of the liquid crystals and therefore may alter the polarisation state of light as it passes through the element.

The system of this example further comprises a polarising beam splitter 160 that splits the beam of light from the illumination source 152 into a transmitted and reflected beam, the reflected beam being reflected towards and subsequently incident upon the liquid crystal layer 154. The transmitted beam may be absorbed elsewhere in the system 150. After passing through the liquid crystal layer 154, the light is incident upon the polarising beam splitter 160, and is again split into a transmitted and reflected beam, the reflected beam being reflected back towards the illumination source 152 and the transmitted beam being ultimately viewable by an observer of the holographic display. In addition to splitting the beam, the polarising beam splitter 160 can also polarise the light incident upon it. In this example, the polarising beam splitter 160 is a linear polariser.

The system of this example further comprises a waveplate 156. In this example, the waveplate 156 is a circular/elliptical polariser, such that circularly or elliptically polarised light is incident upon the liquid crystal layer 154, and subsequently, circularly or elliptically polarised light is incident upon the polarising beam splitter 160 after passing through the liquid crystal layer 154, and the waveplate 156 a second time.

FIG. 4 further depicts a controller 158 that can control the electric fields/voltages applied to each element of the liquid crystal layer 154 to provide full control over the amplitude (and possibly phase) modulation of light output by the system 150. The controller 158 may also control operation of the illumination source 152.

In another example, rather than having a polarising beam splitter, the system comprises a non-polarising beam splitter, an input polariser and an output polariser, where both polarisers are circular/elliptical polarisers. The light would travel from the illumination source, through the input polariser, through the beam splitter, through the liquid crystal layer, through the beam splitter, and then through the output polariser.

Use of a polarising beam splitter can be beneficial over a non-polarising beam splitter by reducing efficiency losses. In both examples, the SLM comprises the liquid crystal layer and the polariser(s) are separate to the SLM.

Mathematically, the SLM (that is, the reflective liquid crystal layer 154) can be described with a Jones matrix J(B), where B is the applied electric field to a particular element of the liquid crystal layer 154, and J is a function of B. The waveplate 156 can have a Jones matrix R, and the polarising beam splitter 160 can be described as removing polarisation p from the output.

R can be chosen such that RJ(B′)Rp=p for some intermediate value of B, denoted B′ (by operating an element of the liquid crystal layer 154 at the second/intermediate electric field). This may be achieved by setting RJ(B′)R=I, where I is the identity matrix. This means that the polarisation of the waveplate cancels out the polarisation effects of the SLM at B′. As a result, when the element is operated at B′, the light incident on the polarising beam splitter 160 (after passing through the element) has the same polarisations state as it was when it was originally incident on the polarising beam splitter 160 (i.e., before being incident upon the element). This means that if the light was reflected by the polarising beam splitter 160 towards the element on the first pass, then it is reflected again on the second pass (i.e., it is reflected back to where it came from originally (i.e., back towards the illumination source). That means no light is seen by the viewer, since the light is “removed” by the polarising beam splitter 160. Conversely, to be seen by a viewer, the light needs to pass through the beam splitter in a direction it did not originally come from (i.e., be transmitted by the polarising beam splitter 160). This is achieved by operating the liquid crystal layer at other values of B, which changes the polarisation state of the light, which therefore allows at least some light get routed to the output (and be seen by the viewer).

As discussed earlier, for reflective liquid crystal layers 154, the Jones matrix of the liquid crystal layer 154, J, describes a double-pass through the SLM. In this example, the light undergoes pure retardance through the SLM (it can be shown that a double pass in opposite directions causes the rotations introduced by the liquid crystal layer to cancel out, leaving only a retardance).

In one example, R is a waveplate with half the retardance of J(B′), and its slow axis aligned to the fast axis of J(B′).

As such, light rays, emitted by the illumination source 152, therefore travel through the liquid crystal layer 154 and are incident upon the polarising beam splitter 160 along the optical path. Depending upon the polarisation of the light as it reaches the polarising beam splitter 160 (which can be influenced by the voltage applied to the particular element), the light may be blocked (when B=B′), or may partially pass through the polarising beam splitter 160.

### Vertically Aligned (VA) Based Liquid Crystal Layer

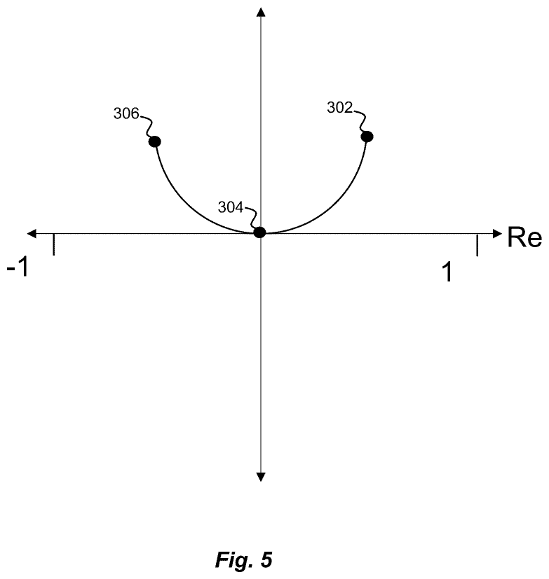

FIG. 5 depicts an example Argand/phasor diagram for the example system 150, where the liquid crystal layer 154 is a VA based liquid crystal layer 154. In this second embodiment, the light incident upon the liquid crystal layer 154 is circularly polarised (as a result of the waveplate 156), and the polarising beam splitter 160 comprises a linear polariser.

VA based liquid crystal layers 154 are typically found in Liquid Crystal on Silicon (LCoS) SLMs. A VA based liquid crystal layer 154 may be characterised as having liquid crystal molecules that are: (i) aligned perpendicular to a plane defined by the liquid crystal layer 154 (i.e., vertically), and (ii) reoriented (as a result of the applied voltage) towards the plane. For example, in absence of an applied voltage, the liquid crystals may be aligned in a vertical arrangement, perpendicular to the plane of the layer 154, and in the presence of an applied voltage, the liquid crystals may be rotated towards the plane. This results in a Jones matrix of the VA liquid crystal layer 154 having complex terms.

In one particular example, the liquid crystal layer 154 has a Jones matrix given by a rotation matrix proportional to:

$$( \begin{matrix}1 & 0 \\ 0 & {e}^{i φ}\end{matrix} )$$

Where φ is a function of the applied voltage to the particular element of the liquid crystal layer 154. Thus, light polarised along a given axis undergoes a phase retardation of φ radians when passing through the liquid crystal layer, and the magnitude of φ is controlled by the magnitude of the applied electric field. Here the polarisation orientation that does not receive a retardation upon an applied electric field is referred to as the ‘fast axis’, and the polarisation orientation that receives a retardation is referred to as the ‘slow axis’. In this example, the fast and slow axis are aligned with the axes 112 and 114, but in general the fast and slow axes do not need to be aligned with the x and y axes of the display. In this particular example, φ is in the range [0, π].

It can therefore be shown that for circularly polarised incident light, such as right hand circularly polarised light (i.e., that is proportional to (1;−i)), and a linear output polarising element 160 arranged at π/4 degrees to the fast axis of the liquid crystal layer, applying a voltage to a particular element of the liquid crystal layer 154 causes both amplitude and phase modulation as depicted in FIG. 5. The phase modulation is dependent on amplitude, giving the relationship shown in FIG. 5.

As mentioned for the first embodiment, the output polarising element 160 is arranged in a particular configuration (and thus has a particular Jones vector), such that as the voltage applied to an element is increased (or decreased), the amplitude of the light passes through zero.

At a first point in time, a first voltage level is applied to an element. In this example, the first voltage level is zero (or 0V). The element is accordingly in a quiescent state because there is no electric field applied to the liquid crystals in the element. When the element is in its quiescent state, φ=0. It can be shown that at this voltage level, the light interacts with the output polarising element of the polarising beam splitter 160 and has a particular non-zero amplitude (that is a percentage of a maximum amplitude in the absence of the output polarising element) and a particular phase modulation. The light is therefore represented on the phasor diagram by point 302, where the light has a particular percentage of its maximum intensity and a phase modulation.

Later, if the voltage is increased from the first voltage level (in this case 0V), to a second (higher, non-zero) voltage level, the polarised light undergoes a rotation within the element. This rotation adjusts the polarisation state and as the light interacts with the output polarising element of the polarising beam splitter 160, the light ray has an amplitude of approximately zero so is blocked by the output polarising element. For example, at this second voltage level, φ=π/2 radians, the right hand circularly polarised light (represented as (1;−i)) is converted into linearly polarised light (represented by (1;1), i.e., +π/4 radians) and the angle of the output polarising element can be set to be −π/4 radians. Hence, at this second voltage level, there is angle of π/2 radians between the polarisation state of the light and the output polarising element and so the light is blocked by the output polarising element (i.e., the amplitude is 0). The light is therefore represented on the phasor diagram by point 304, where the light has approximately 0% of its maximum intensity.

Later still, if the applied voltage continues to be increased from the second voltage level to a third (higher, non-zero) voltage level (which may be a maximum voltage), the light is rotated further. For example, at this third voltage level, φ=π radians. This rotation adjusts the polarisation state and as the light interacts with the output polarising element of the polarising beam splitter 160, the transmitted light ray has a non-zero amplitude (that is a percentage of a maximum amplitude in the absence of the output polarising element) and a particular phase modulation. Due to the extent of the rotation, the light is represented in a different quadrant on the phasor diagram. This is effectively represented as light having a “negative” amplitude. Accordingly, the light is represented on the phasor diagram by point 306, where the light has a percentage of its maximum intensity and a particular phase modulation.

FIG. 5 therefore illustrates how the amplitude of light can be modulated through 0 by arranging an output polarising element having a particular Jones vector, such that as the voltage applied to an element is increased from a first voltage level to a third voltage level via a second voltage level, the amplitude decreases from a particular level to zero and then increases again. The zero amplitude is achieved at this second, intermediate voltage level. It will be appreciated that the same effect can be achieved when the voltage is decreased from a first voltage level to a third voltage level. For example, the first voltage level may be a maximum voltage level, and it is decreased to a third, zero voltage level, via a second intermediate voltage level. The overall modulation scheme applied by the example system is given by (1+i e^{iϕ})/2.

A commercially available LCoS SLM is the Sony™ SXRD241A, which has a VA modality. The simplified model for a VA liquid crystal layer suggests a circular input polarisation and a linear output polarisation. Informed by this, to achieve through-zero operation, the SLM is illuminated by circularly polarised light (achieved via the waveplate 156 for example), and the orientation of a linear output polariser (such as the polarising beam splitter 160) is then set such that the modulated amplitude at zero voltage is approximately equal to the modulated amplitude at maximum voltage, and passes through zero at an intermediate voltage. For this particular Sony™ LCoS SLM, the output polariser orientation is approximately 25 degrees from the y axis of the SLM (i.e., axis 112).

### “Low Twist” Twisted Nematic (TN) Based Liquid Crystal Layer

FIG. 5 is also representative of an example system 150, where the liquid crystal layer 154 is a “low twist” TN based liquid crystal layer 154. Some example TN based liquid crystal layers (e.g., a double-pass through a reflective TN layer) can be described as a pure retardance, with little to no effect from the twist of the TN. Such TN based liquid crystal layers may be referred to as a “low twist” TN based liquid crystal layer (relative to a more typical TN liquid crystal layer, such as that described earlier). As with the second embodiment discussing VA based liquid crystal layers, in this third embodiment, the light incident upon the liquid crystal layer 154 is circularly polarised (as a result of the waveplate 156), and the polarising beam splitter 160 comprises a linear polariser.

A low twist TN based liquid crystal layer 154 may be characterised as having liquid crystal molecules that are: (i) aligned parallel to a plane defined by the liquid crystal layer 104 in absence of an applied electric field/voltage (when the electric field/voltage is zero), and (ii) reoriented/rotated (as a result of a non-zero electric field/voltage being applied) away from the plane. Reorientating/rotating away from the plane may be referred to as rotating towards being perpendicular to the plane. In one particular example, the liquid crystal layer 154 has a Jones matrix given by a rotation matrix that is the same as the Jones matrix for the VA based liquid crystal layer provided above. As for the VA based liquid crystal layer, φ is in the range [0, π], but in contrast to the VA based liquid crystal layer, φ=π when an element of liquid crystal layer is in a quiescent state, and φ=0 when the electric field applied to the element is at a maximum. As such, the TN based liquid crystal layer 154 behaves similarly to the VA based liquid crystal layer, and the overall modulation scheme applied by the example system is given by (1+i e^{iϕ})/2.

### Filtering

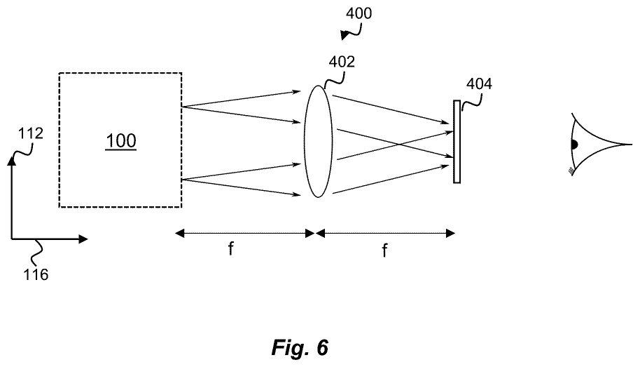

FIG. 6 depicts at least part of a holographic display 400 according to an example. The holographic display 400 includes the system 100 of FIGS. 1 and 2 or the system 150 of FIG. 4. In addition to the components of the system 100, 150, the display 400 further comprises a lens 402. The lens 402 has a focal length, f, and in this particular example, is positioned one focal length from the SLM of the system 100, 150. In other examples, the distance between the lens 402 and the SLM may be different. The display 400 further comprises a filter 404, such as a spatial filter, delimiting an aperture. The filter 404 is positioned one focal length from the lens 402, on the opposite side of the lens 402 from the SLM. As shown, the SLM, lens 402 and filter 404 are coaxial along the optical axis 116. Other configurations may also be used, such as a folded light path that may allow a more compact display.

The SLM is configured to generate a light field which is a quantised representation of a target light field, H, as has been discussed above. The arrangement of the holographic optical display 400 is such that the Fourier transform of the light field, F(H), is formed at a plane coinciding with the position of the filter 404. This plane is the Fourier plane of the SLM as imaged by the lens 402. The target light field is determined such that the Fourier transform of the target light field, F(H), does not overlap at least the Fourier transform of the complex conjugate of the target light field, F(H*) in the Fourier plane of the SLM. Further, the aperture in the filter 404 is positioned such that portions of the target light field are blocked. For example, the filter is arranged to remove a Fourier transform of complex conjugate of target light field, F(H*). This can be effective to reduce the effect of quantisation noise. As mentioned, due to the specific modulation scheme discussed in FIGS. 1-5, the filter does not necessarily need to filter a zero order of the target light field. However, as mentioned, the zero-order may still be filtered, in some examples, but due to the lower energy in the zero-order, the filtering is easier than in conventional systems. The zero-order can therefore still be filtered to remove any residual zero-order.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A holographic display, comprising:
an illumination source configured to emit at least partially coherent light;
a liquid crystal layer comprising an array of elements arranged to be illuminated by the light and configured such that:
when a first electric field is applied across an element of the liquid crystal layer, the light from the element has a first polarisation state;
when a second electric field is applied across the element of the liquid crystal layer, the light from the element has a second polarisation state; and
when a third electric field is applied across the element of the liquid crystal layer, the light from the element has a third polarisation state;
a controller configured to control electric fields applied across the elements of the liquid crystal layer; and
an output polarising element configured to:
remove a portion of light having the first polarisation state and also transmit a portion of the light having the first polarisation state;
remove substantially all of the light having the second polarisation state; and
remove a portion of the light having the third polarisation state and also transmit a portion of the light having the third polarisation state;
wherein one of:
the second electric field is greater than the first electric field, and the third electric field is greater than the second electric field; and
the second electric field is lower than the first electric field, and the third electric field is lower than the second electric field.

2. The holographic display according to claim 1, wherein:
the controller is configured to control electric fields applied across the elements of the liquid crystal layer by controlling voltages applied to the elements of the liquid crystal layer; and
the liquid crystal layer is configured such that:
when the element is operated at a first voltage level, the first electric field is applied across the element;
when the element is operated at a second voltage level, the second electric field is applied across the element; and
when the element is operated at a third voltage level, the third electric field is applied across the element.

3. The holographic display according to claim 2, wherein:
when the second electric field is greater than the first electric field, and the third electric field is greater than the second electric field:
the first voltage level is a zero voltage;
the second voltage level is a non-zero voltage; and
the third voltage level is a non-zero voltage; and
when the second electric field is lower than the first electric field, and the third electric field is lower than the second electric field:
the first voltage level is a non-zero voltage;
the second voltage level is a non-zero voltage; and
the third voltage level is a zero voltage.

4. The holographic display according to claim 1, wherein light incident upon the element of the liquid crystal layer is linearly polarised and wherein the output polarising element comprises a linear output polariser.

5. The holographic display according to claim 4, wherein the liquid crystal layer comprises liquid crystals that are configured to align parallel to a plane of the liquid crystal layer when the first, second and third electric fields are applied across the element.

6. The holographic display according to claim 4, wherein the light incident upon the liquid crystal layer has a polarisation state, and the output polarising element is orientated to transmit substantially all light having the particular polarisation state.

7. The holographic display according to claim 6, wherein the liquid crystal layer forms at least part of a reflective spatial light modulator, SLM, and the light is configured to pass through the output polarising element, both:
before being incident upon the element of the liquid crystal layer; and
after passing through the element of the liquid crystal layer.

8. The holographic display according to claim 4, wherein the liquid crystal layer comprises liquid crystals that are configured to align parallel to a plane of the liquid crystal layer when the electric field applied across the element is zero, and rotate away from the plane when a non-zero electric field is applied.

9. The holographic display according to claim 1, wherein light incident upon the element of the liquid crystal layer is circularly polarised and wherein the output polarising element comprises a linear output polariser.

10. The holographic display according to claim 9, wherein the liquid crystal layer comprises liquid crystals that are configured to:
align perpendicular to a plane of the liquid crystal layer when the electric field applied across the element is zero; and
rotate towards the plane when the electric field applied across the element is non-zero.

11. The holographic display according to claim 9, wherein the liquid crystal layer comprises liquid crystals that are configured to align parallel to a plane of the liquid crystal layer when the electric field applied across the element is zero, and rotate away from the plane when a non-zero electric field is applied.

12. The holographic display according to claim 1, wherein:
light incident upon the element of the liquid crystal layer has an initial polarisation associated with a first Jones vector;
the output polarising element is associated with a second Jones vector;
the element of the liquid crystal layer is associated with a Jones matrix, wherein the Jones matrix for the element is a function of the electric field applied to the element; and
the second Jones vector is based on the Jones matrix and the first Jones vector.

13. The holographic display according to claim 1, wherein the display further comprises:
a polarisation modifying element arranged between the output polarising element and the liquid crystal layer and configured to modify a polarisation state of light; and
a polarising beam splitter comprising the output polarising element and configured to remove substantially all of the light having the second polarisation state, p; and
wherein:
the liquid crystal layer forms at least part of a reflective SLM;
the element of the liquid crystal layer is associated with a Jones matrix, J(B), wherein the Jones matrix for the element is a function of the electric field, B, applied to the element;
the polarisation modifying element is associated with a Jones matrix, R; and
RJ(B′)Rp=p, where J(B′) is the Jones matrix associated with the element of the liquid crystal layer at the second electric field, B′.

14. The holographic display according to claim 13, wherein the polarisation modifying element is a waveplate having half the retardance of J(B′) and a slow axis aligned to a fast axis of J(B′).

15. The holographic display according to claim 1, further comprising:
a lens arranged to receive light transmitted by the output polarising element and configured to generate a Fourier transform, F(H), of a target light field at a focal plane of the lens; and
a spatial filter positioned at the focal plane and configured to remove a Fourier transform of complex conjugate of target light field, F(H*).

16. The holographic display according to claim 15, wherein the spatial filter is configured to remove the Fourier transform of complex conjugate of target light field, F(H*) and a zero order of the target light field.

17. The holographic display according to claim 15, wherein the spatial filter is configured to remove the Fourier transform of complex conjugate of target light field, F(H*) without filtering a zero order of the target light field.

18. The holographic display according to claim 1, wherein:
when the first electric field is applied across the element, the light has a first phase;
when the third electric field is applied across the element, the light has a second phase;
wherein the first phase and the second phase are located in different quadrants on an Argand diagram.
